(19) United States
(12) Patent Application Publication
(10) Pub. No.: US 2020/0384418 A1
(43) Pub. Date: Dec. 10, 2020

(54) WATER FILTRATION MODULE INCORPORATING HOLLOW-FIBER FILTRATION ELEMENTS

(71) Applicant: POLYMEM, CASTANET TOLOSAN (FR)

(72) Inventors: JEAN-MICHEL ESPENAN, DEYME (FR); FRANC SAUX, SAINTE FOY D'AIGREFEUILLE (US); PATRICK SANTALO, SAINT VINCENT (FR)

(21) Appl. No.: 16/961,251

(22) PCT Filed: Jan. 14, 2019
(86) PCT No.: PCT/FR2019/050066

§ 371 Date: Jul. 9, 2020

(30) Foreign Application Priority Data
Jan. 15, 2018 (FR) 1850282

(51) Int. Cl. B01D 63/04; B01D 61/18

(52) U.S. Cl. CPC B01D 63/04; B01D 61/18; B01D 2313/025; B01D 2321/185; B01D 2313/10; B01D 2313/21; B01D 2315/20; B01D 2313/06

(57) ABSTRACT

A water filtration module includes filtration elements, each formed from a bundle of hollow fibers. In each element, the end portions of the fibers are included in the coating blocks that do not close them, and a longitudinal hollow tube is arranged at the center of the bundle, so as to open on either side of the coating blocks. Each element includes a cap attached around the lower coating block providing a chamber in hydraulic communication with the hollow fibers and with the central tube. The set of elements are assembled removably in a housing of the module, such that an upper permeate collection chamber of the module is in hydraulic communication with the hollow fibers and the central tubes of each of the elements.

In the preferential mode of implementation thereof, said modules are supplied with untreated water by the upper end thereof. The hollow fibers are open at the upper end thereof and closed at the lower end thereof, so that the purified water, after having passed through the wall of hollow fibers, emerges therefrom in the upper portion of the filtration module, where it is collected. The treatment sludges, for their part, are evacuated by a lower drain.

Although water treatment installations based on such filtration modules make it possible to filter large volumes of water effectively, while occupying a small ground surface area and while being simple and quick to install, these installations nevertheless require for the operation thereof an amount of energy that may be too important for some users.

### OBJECT AND SUMMARY OF THE INVENTION

The aim of the present invention is to remedy the drawbacks of the water filtration modules proposed by the prior art, in particular the drawbacks described above, by proposing a water filtration module of the hollow-fiber type, which makes it possible to provide an effective filtration of large volumes of water while being less energy-consuming for its operation than the hollow-fiber based filtration modules proposed by the prior art.

Additional aims of the invention are that such a water filtration module is easy to manufacture, at low cost, and the water filtration elements entering into the composition thereof can be easily mounted and dismantled in order to be replaced.

To this end, it is advantageously proposed by the present inventors to reduce the energy demand of water filtration modules by reducing the water pressure needed to operate said filtration modules. Typically, for the traditional water filtration modules proposed by the prior art, such as the filtration modules described in document WO 2011/157835, the water pressure needed for correct operation is at least equal to 0.5 bars.

It is now advantageously proposed by the present invention a water filtration module, of the type comprising a plurality of hollow fibers configured to enable a filtration of water from the outside towards the inside of the fibers, which is capable of operating effectively at a water pressure as low as 0.3 bars. Such a reduction of the water pressure needed to operate the filtration module according to the invention makes it possible to achieve significant energy savings, particularly for large water treatment installations, intended to supply communities with potable water.

Thus, it is proposed according to the present invention a water filtration module of the hollow fiber type, comprising:

a casing having a longitudinal axis,

a plurality of water filtration elements independent from one another, assembled removably in the casing so as to extend along said longitudinal axis, each of the water filtration elements being such that:
it comprises a plurality of longitudinal hollow fibers configured to enable a filtration of water from the outside towards the inside of the fibers, said fibers together forming a bundle of fibers extending along a longitudinal axis and having an upper end portion and an opposite lower end portion,
the upper end portion of the fibers is included in a first rigid coating block, said first rigid coating block not closing the fibers in the upper end portion thereof, and

an upper permeate collection chamber in hydraulic communication with the hollow fibers of all the water filtration elements.

Here, independent from one another means the fact that the filtration elements are not linked to one another, and in particular are not potted in one or more shared coating block(s).

According to the invention, each of the water filtration elements is such that:

the lower end portion of the fibers is included in a second rigid coating block, said second rigid coating block not closing the fibers in the lower end portion thereof,

a longitudinal hollow tube, known as central tube, is arranged in the bundle of fibers, substantially at the center of the latter, so as to extend at least over the entire height of the bundle, preferably along a longitudinal axis substantially coaxial with the longitudinal axis of the bundle of fibers, and to open on either side of the first coating block and of the second coating block,

the filtration element further comprises a cap fluid-tightly attached around the second coating block. Said cap is arranged so as to provide, between same and the second coating block, a chamber, called lower chamber, which is in hydraulic communication with the hollow fibers and with the central tube, at the lower portion of the fibers.

The central tubes of each of the water filtration elements are in hydraulic communication with the upper permeate collection chamber at the upper portion of the fibers.

The water filtration module according to the invention thus includes an upper permeate collection chamber that is collective, that is to say shared by all of the water filtration elements of the module, and a plurality of lower chambers that are individual, each being associated to one of the water filtration elements of the module.

As described above, such a water filtration module is advantageously capable of operating with very low inlet water pressures, while producing a filtration almost just as efficient, or even just as efficient, as the filtration modules of the hollow-fiber bundle type proposed by the prior art. Particularly, it has been discovered by the present inventors that surprisingly, the insertion of a tube into the bundle of fibers, substantially at the center of the latter, has very little, or even no impact at all, on the filtration efficiency of the filtration element, for the same diameter of the bundle of hollow fibers, when the external dimensions of the central tube remain small in relation to said diameter. Preferably, the external diameter of the central tube is chosen so as not to reduce by more than 5 to 6% the filtration surface of the filtration element, compared to a configuration wherein the space occupied by the central tube would be occupied by hollow fibers, normally spaced apart from one another. By way of example, for a bundle of external diameter of approximately 6.4 cm, comprising approximately 3,500 hollow fibers, the filtration efficiencies are not impacted much when the central tube has an external diameter less than or equal to 1.2 cm. This external diameter is for example between 1 and 2.5 cm.

Such a surprising result may in particular be partly explained by the fact that the hollow fibers located at the center of the bundle of fibers, which according to the invention are replaced by the central tube, are the least active for the filtration. Furthermore, the fact that the hollow fibers are open at each of their opposite ends enables a more effective washing thereof, so that the filtration efficiency thereof is better maintained over time. Thus, it is possible to produce, for the same inflow, more outflow from the filtration element, the average operating membrane pressure in the filtration element according to the invention, over the length of the fibers, being advantageously lower for a same given inflow.

Furthermore, it has been discovered by the present inventors that, particularly surprisingly, the implementation in the water filtration module according to the invention of a plurality of “central tube/lower chamber” pairs, each of said pairs being associated with a specific group of fibers, forming the bundle of fibers of an individual water filtration element, increases the efficiency of the water filtration module according to the invention in relation to filtration modules wherein a single tube and a single lower chamber are shared by all of the fibers of the filtration module, as described for example in document KR 20160080010. Said document KR 20160080010 describes a filtration module wherein all the fibers are associated with a single central tube and with a single lower chamber, for a collective collection of the filtration permeate escaping from the fibers at the lower end thereof.

Compared to such a configuration proposed by the prior art, the complexity of the filtration elements of the water filtration module according to the invention is advantageously offset by the ease of mounting/dismantling said filtration elements in the water filtration module.

If needed, the reduction of the filtering surface induced by the presence of a central tube in each bundle of fibers may in particular be offset by an increase of the height of the hollow fibers implemented, this advantageously being able to be carried out with a small additional cost, and with no impact on the footprint of the installation incorporating the filtration elements.

During the implementation of the filtration module according to the invention, when untreated water is injected into the filtration module wherein same is arranged, said water, arriving from the upper portion or the lower portion of the module on the outside of the hollow fibers, passes through the wall of the fibers. A portion of the filtration permeate rises through the upper end of the fibers, into the upper permeate collection chamber wherein open the fibers at the upper end of the module. Another portion of the filtration permeate goes down inside the fibers to the lower end of the fibers, then into each lower chamber provided between the lower portion of the fibers and each associated cap. From there, the permeate rises into the central tube, until joining the upper portion of the filtration module, and in particular the upper permeate collection chamber. The configuration of the water filtration module according to the invention, and more specifically of the water filtration elements that it contains, advantageously significantly reduces the pressure losses related to the circulation of the liquid in the element, and this by approximately 40% in relation to the configurations wherein the bundles of fibers do not comprise a central tube.

The water filtration module according to the invention may further meet one or more features described below, implemented alone or in each of the technically operating combinations thereof.

In specific embodiments of the invention, in at least one of the water filtration elements, preferably in all of the water filtration elements, the cap is irreversibly attached around the second coating block. It is for example attached by bonding or by welding, particularly to a lower sleeve fitting tightly around the hollow fibers in the lower end portion thereof. Such a lower sleeve may then be conventional in itself for water filtration elements of this type.

Such a configuration in particular offers the advantage of a simplified method for manufacturing component parts of the filtration element of the water filtration module according to the invention.

In variants of the invention, in at least one of the water filtration elements, preferably in all of the water filtration elements, the cap is reversibly attached around the second coating block. It is for example attached by screwing, particularly around a lower sleeve fitting tightly around the hollow fibers in the lower end portion thereof. In such a configuration, the cap and the lower sleeve are provided with cooperating attachment means. The cap may for example comprise a threaded area suitable for being screwed into a complementary tapped area formed on the outer surface of the lower sleeve.

Such a configuration in particular offers the advantage of making it possible to dismantle the cap, in particular to enable access to the lower end of the hollow fibers.

In preferred embodiments of the invention, in at least one of the water filtration elements, preferably in all of the water filtration elements, the bundle of fibers is held in shape by a grid, that is to say an envelope with openwork wall, which surrounds same. Said grid is preferably flexible or semi-rigid. Advantageously, said grid has a low thickness, particularly a thickness between 0.5 and 3 mm. It further preferably has a high surface perforation rate, particularly between 20 and 80%. Such features, which are advantageously made possible by the rigidification of the bundle of fibers induced by the presence in the latter of the central tube, which is preferably rigid, said tube moreover being potted in the coating blocks of the end portions of the fibers, advantageously reduce the manufacturing cost of the water filtration elements entering in the composition of the water filtration module according to the invention, in relation to the water filtration elements of the prior art, which comprise grids for holding in shape bundles of fibers that are thicker and less open worked. Said features further make it possible to incorporate more filtration fibers into a filtration element of the same external diameter, and they facilitate the passage of the water to be filtered towards the fibers, and of the washing water in the opposite direction, consequently improving, more so, the filtration efficiency of the water filtration module according to the invention.

In preferred embodiments of the invention, at least one of the water filtration elements, preferably all of the water filtration elements, comprises an upper sleeve fitting tightly around the bundle of fibers at the upper end portion thereof and a lower sleeve fitting tightly around the bundle of fibers at the lower end portion thereof. When the bundle of fibers is further held in shape by a grid, in particular a flexible grid, the latter preferably attaches respectively to said upper sleeve and to said lower sleeve.

The upper sleeve may be conventional in itself, and in particular comprise means for mounting the filtration element in the filtration module.

In specific embodiments of the invention, at least one water filtration element, preferably all of the water filtration elements, comprises an air injector extending around the central tube at the lower end portion of the fibers and opening into the bundle of fibers beyond the second rigid coating block, in the middle of the bundle of fibers. In particular, such a feature advantageously makes it possible to inject air inside the bundle of fibers, in order to perform a washing of the fibers. This washing is particularly effective, in particular because the air injected around the central tube then diffuses particularly well in all directions in the bundle of fibers, from the center of the latter.

In the water filtration module according to the invention, the water filtration elements are assembled removably in the casing, by cooperating assembly means supported respectively by the module and by each of the elements.

Said cooperating assembly means may be conventional in themselves. They are preferably arranged in the upper portion of the filtration module.

In specific embodiments of the invention, the water filtration module comprises an upper plate arranged in the casing. The water filtration elements are preferably suspended on said upper plate, so as to substantially extend along the longitudinal axis of the casing. The water filtration module according to the invention then comprises cooperating assembly means supported respectively by the upper plate and by the filtration elements, for the removable assembly of the filtration elements to the upper plate.

The supply of the filtration module according to the invention in water to be filtered may be carried out by the upper end or by the lower end of the module.

In specific embodiments of the invention, it is arranged in the casing a strainer coaxial with the longitudinal axis of the casing, of length substantially equal to the length of the casing, for the distribution of water to be filtered in the casing.

The strainer is preferably arranged substantially at the center of the casing, the water filtration elements being arranged around said strainer in the casing, preferably arranged at regular intervals in a plurality of concentric circles around the strainer.

The filtration module according to the invention may also be devoid of strainer, the water to be filtered then having to be brought thereto in a pre-filtered form.

The casing may also contain, conventionally in itself, a lower chamber for collecting filtration sludges, that is to say solid or semi-solid particles contained in the effluent to be filtered, which have not passed through the wall of the hollow fibers.

In the specific configurations of the invention wherein at least one of the water filtration elements comprises an air injector extending around the central tube at the lower end portion of the fibers and opening into the bundle of fibers beyond the second rigid coating block, in the middle of the bundle of fibers, the filtration module according to the invention may further comprise, preferably in the casing, a baseplate comprising a circuit for distributing air from an aeration nozzle that then comprises the filtration module, to said air injector.

According to another aspect, the present invention concerns a method for manufacturing a water filtration module according to the present invention, meeting one or more of the features above or below. Said method includes steps of:

manufacturing a plurality of water filtration elements, including for each of said water filtration elements steps of:
assembling longitudinal hollow fibers in a bundle around a longitudinal hollow central tube, parallel to the longitudinal axis of said latter, said central tube extending at least over the entire height of the bundle, the bundle of fibers preferably being held in shape by a grid that surrounds it,
coating the upper end portion of said fibers in a first coating block not closing the fibers and not closing the central tube at said upper end portion, and coating the lower end portion of the fibers in a second coating block not closing the fibers and not closing the central tube at said lower end portion, and
fluid-tightly attaching a cap around the second coating block, said cap being arranged so as to provide, between same and the second coating block, a chamber in hydraulic communication with the hollow fibers and with the central tube, and

assembling removably the plurality of filtration elements in the casing, so that the upper permeate collection chamber is in hydraulic communication with the hollow fibers and the central tubes of all the water filtration elements, at the upper portion of the fibers.

The fluid-tight attachment of the cap around the second coating block may be carried out irreversibly, for example by bonding or welding, or reversibly, for example by screwing, said attachment preferably being carried out to a lower sleeve fitting tightly around the bundle of fibers at the lower end portion of the fibers.

The steps of coating the upper end portion and the lower end portion of the fibers may be performed according to any technique conventional in itself. They may for example use a bi-component resin, wherein the end portions of the fibers are inserted before hardening of the resin so as to form a rigid block coating the end portions of the fibers, without nevertheless closing the latter at the end portions thereof.

For the removable assembly thereof in the filtration module, at least one water filtration element according to the invention, preferably all of the water filtration elements according to the invention, are suspended in the casing, in particular to the upper plate, around the strainer for distributing water to be filtered.

Another aspect of the invention concerns a water treatment installation, which comprises:

a water filtration module according to the invention, meeting one or more of the features described above or below,

a pipe supplying water to be filtered in the casing, preferably connected to an upper end of the strainer,

a filtration permeate collection pipe connected to the upper permeate collection chamber.

Preferably, the installation also comprises a filtration sludge evacuation drain connected to the lower filtration sludge collection chamber.

If applicable, same may further comprise a compressed air distribution system linked to the aeration nozzle of the water filtration module, when said water filtration module comprises such an aeration nozzle.

The water treatment installation may further comprise a PLC controlling valves of the various pipes, drains and circuits, said PLC being attached to the water filtration module conventionally in itself, and any other member or device conventional in itself.

Another aspect of the invention concerns a water filtration element configured to be assembled removably in a water filtration module according to the invention. Said water filtration element may meet one or more of the features described above with reference to the water filtration module according to the invention. Particularly, it comprises a plurality of longitudinal hollow fibers configured to enable a filtration of water from the outside to the inside of the fibers, said fibers forming a bundle of fibers extending along a longitudinal axis and having an upper end portion and an opposite lower end portion.

According to the invention, the upper end portion of the fibers is included in a first rigid coating block not closing the fibers in the upper end portion thereof, and the lower end portion of the fibers is included in a second rigid coating block not closing the fibers in the lower end portion thereof.

A longitudinal hollow tube, called central tube, is arranged in the bundle of fibers, at the center of said bundle, so as to extend at least over the entire height of the bundle and to open on either side of the first coating block and of the second coating block,

The filtration element further comprises a cap fluid-tightly attached around the second coating block, this cap being arranged so as to provide, between same and the second coating block, a lower chamber in hydraulic communication with the hollow fibers and with the central tube, at the lower end portion of the fibers.

Preferably, the bundle of fibers is held in shape by a grid, in particular flexible, which surrounds same.

### BRIEF DESCRIPTION OF THE DRAWINGS

The features and advantages of the invention will become clearer in light of the examples of implementation below, provided by way of simple illustrative and non-limiting example of the invention, with the support of FIGS. 1 to 8, wherein:

FIG. 1 shows a water filtration element according to a specific embodiment of the invention, in sectional view with respect to a longitudinal plane;

FIG. 2 shows an enlargement of the upper end portion of the water filtration element of FIG. 1;

FIG. 3 shows an enlargement of the lower end portion of the water filtration element of FIG. 1;

FIG. 4 shows an enlargement of a sectional view with respect to a longitudinal plane of the lower end portion of a water filtration element according to a different embodiment of the invention;

FIG. 5 shows an enlargement of a sectional view with respect to a longitudinal plane of the lower end portion of a water filtration element according to another different embodiment of the invention;

FIG. 6 shows a sectional view with respect to a longitudinal plane of a water filtration module according to a specific embodiment of the invention;

FIG. 7 shows an enlargement of the upper portion of the water filtration module of FIG. 6; and

FIG. 8 shows an enlargement of the lower portion of the water filtration module of FIG. 6.

### DETAILED DESCRIPTION OF THE EMBODIMENTS

A water filtration module according to the invention comprises a plurality of water filtration elements, which preferably are all made in an identical way.

### Water Filtration Element

A water filtration element 10 according to the invention (below named “element”) is shown in FIG. 1.

This element 10 has a longitudinal overall shape, substantially cylindrical in said exemplary embodiment. It comprises a bundle 101 of longitudinal hollow fibers 102, said bundle here also being substantially cylindrical.

In the embodiment described here by way of non-limiting example, the filtration hollow fibers 102 each have a diameter of a few tens of millimetres for a length of approximately 1.5 m. The dimensional and material features thereof are known by the person skilled in the art and depart from the scope of the present invention. Therefore, they are not described further here.

The bundle 101 comprises a plurality of thousands (typically approximately 4,000) of hollow fibers 102, whereof the porous wall constitutes a filtration membrane. Such a bundle 101 may for example have a diameter of 5 to 7 cm.

The bundle 101 is held in shape by a grid, for example made of plastic material 110, which surrounds same. Said grid makes it possible to hold the general shape of the bundle, while allowing the fibers 102 to move naturally in the water flow when they are in use. This grid has for example a thickness between 0.5 and 3 mm, and a surface rate of perforations between 20 and 80%. Preferably, it is advantageously flexible.

At an upper end portion, at the top in FIG. 1, the hollow fibers 102 open out from a first rigid coating block of resin 103, called upper coating block, for example of bi-component type, known per se, for example of a height of approximately 5 cm. It is understood that, in this way, the water passing through the wall of the fibers 102, from the outside to the inside of the fibers, may circulate inside the fibers towards the upper end portion thereof, to exit therefrom at the upper end 1021 of the fibers.

At a lower end portion, at the bottom in the figure, the hollow fibers 102 also open out from a second rigid coating block of resin 104, called lower coating block, for example of bi-component type, known per se, for example of a height of approximately 5 cm. The water circulating inside the fibers 102 may thus also exit therefrom at the lower end 1022 of the fibers.

At its upper end portion, the bundle of fibers 101 is fitted tightly in an upper sleeve 105, arranged in particular around the upper coating block 103. At the lower end portion thereof, it is fitted tightly in a lower sleeve 106, arranged in particular around the lower coating block 104. These sleeves, whereof one embodiment will be described in a more detailed way below, are conventional in themselves.

The element 10 also comprises a hollow longitudinal tube 107, called central tube, which is arranged substantially at the center of the bundle of fibers 101, coaxially with said latter, and so as to extend at least over the entire length of said bundle 101. Particularly, the central tube 107 opens, at the upper end 1071 thereof, out of the upper coating block 103, and at the lower end 1072 thereof, out of the lower coating block 104.

The central tube 107 is substantially cylindrical in the embodiment shown in the figures. It has for example a diameter of approximately 1.2 cm.

At the lower end portion thereof, the element 10 is covered by a cylindrical cap 108, which is fluid-tightly attached around the lower coating block 104. The cap 108 is more specifically attached on the lower sleeve 106. It creates, between it and the lower coating block 104, a watertight lower chamber 109 that is in hydraulic communication with the fibers 102 at the lower end 1022 thereof, and with the central tube 107 at the lower end 1072 thereof. This lower chamber 109 has for example a height of approximately 1 cm.

The cap 108 comprises a bottom wall 1081, which closes the element 10 at the lower end thereof, and a peripheral wall 1082, which surrounds the lower sleeve 106 over the entire circumference thereof.

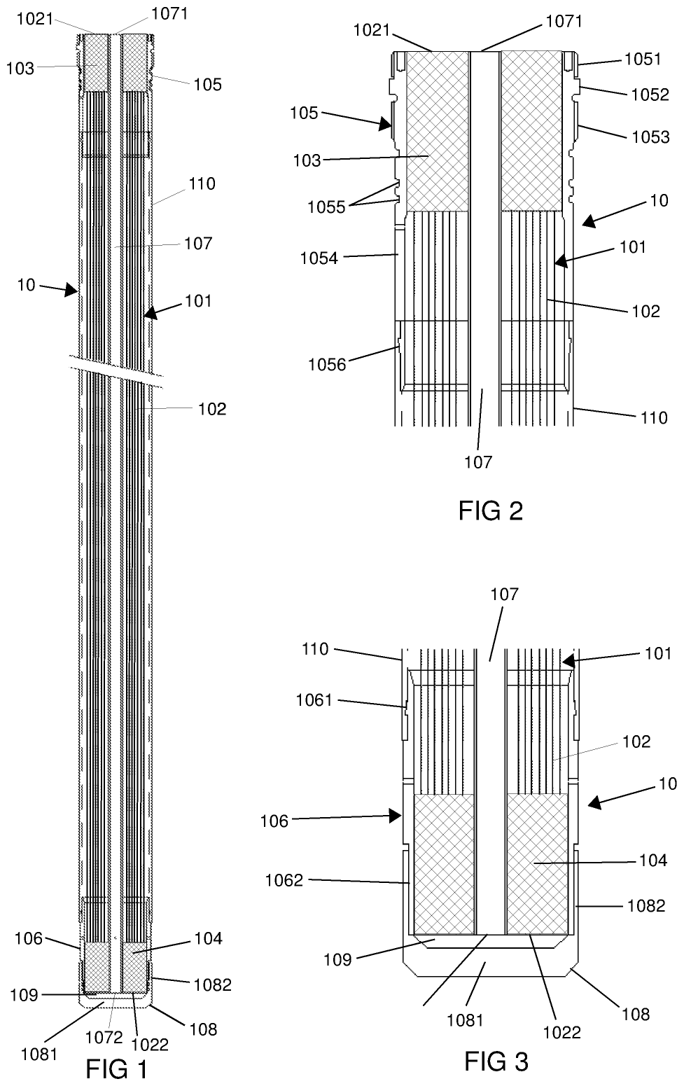

As shown in FIG. 2, the upper sleeve 105 fits tightly around the hollow fibers 102 in the upper end portion of the element 10, at the upper coating block 103. The upper sleeve 105 comes to the same level as the upper end 1021 of the fibers 102 and extends over tens of centimeters along the element 10.

As can be seen in FIG. 2, the outer profile of this upper sleeve 105, although mainly cylindrical, comprises from top to bottom:
a first threaded area 1051, extending for example over 0.5 to 1 cm,
a bearing ring 1052,
a second threaded area 1053, extending for example over a height of approximately 2 cm,
a smooth area 1054 comprising grooves 1055 intended for the insertion of two O-rings (not illustrated in the figure),
a lower area 1056, substantially frustoconical tapering towards the bottom, intended to accommodate the upper edge of the grid 110 that fits tightly around the hollow fibers 102 of the element 10. Preferably, this lower area 1056 comprises surface textures (not illustrated), substantially complementing the shape of the grid 110, and intended to enable the interlocking and locking of the grid 110 on the upper sleeve 105.

As shown in FIG. 3, the lower sleeve 106 fits tightly around the hollow fibers 102 in the lower end portion of the element 10, at the lower coating block 104. The lower sleeve 106 comes to the same level as the lower end 1022 of the fibers and extends over tens of centimeters along the element 10.

In the embodiment shown in FIG. 3, the lower sleeve 106 is substantially cylindrical, and it comprises in the upper portion thereof a frustoconical area 1061, of profile substantially identical to the profile of the lower area 1056 of the upper sleeve 105, and also intended to enable the interlocking and the locking of the grid 110 on this lower sleeve 106.

In the specific embodiment of the invention shown in FIG. 3, the cap 108 is irreversibly attached, for example glued or welded, around the lower area 1062 of the lower sleeve 106. To this end, said lower area 1062 is smooth.

The tightness of the attachment is provided by a seal arranged between the cap 108 and the lower area 1062 of the lower sleeve (not shown in the figures).

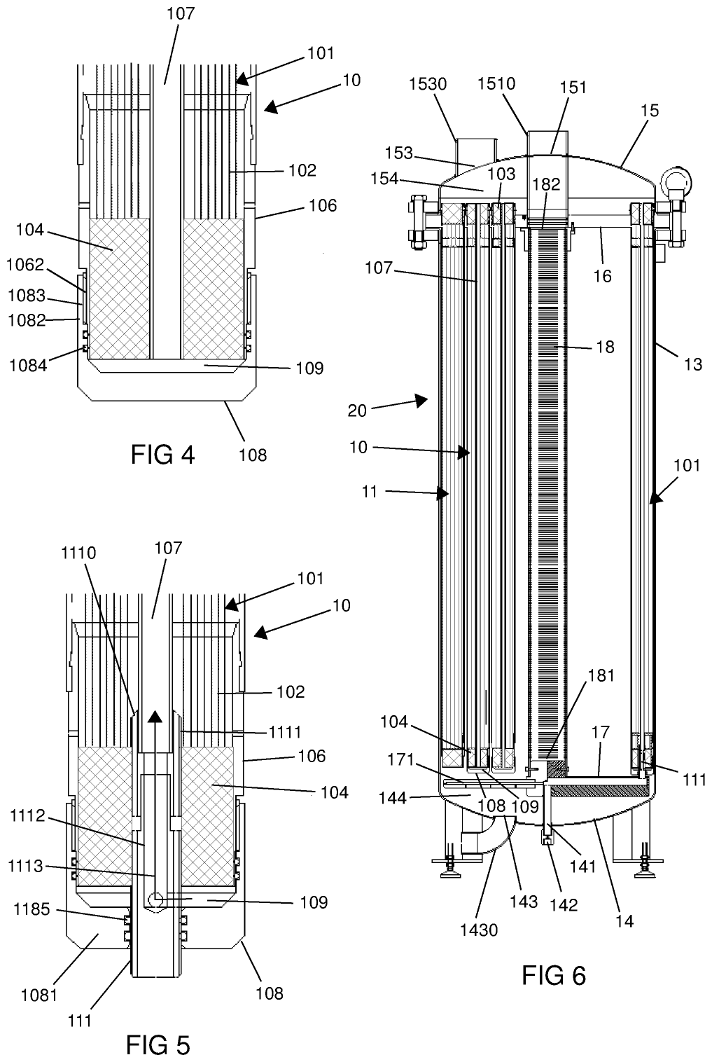

A variant of the lower end portion of an element 10 according to the invention is shown in FIG. 4. In said variant, the cap 108 is reversibly attached to the lower sleeve 106, for example by screwing. To this end, the cap 108 and the lower sleeve 106 are provided with cooperating attachment means. The cap 108 may for example comprise, in the peripheral wall 1082 thereof, a threaded area 1083 suitable for being screwed into a complementary tapped area formed on the outer surface of the lower area 1062 of the lower sleeve 106, as shown in FIG. 4. O-rings 1084, for example two in number in the figure, are inserted between the peripheral wall 1082 of the cap 108 and the outer surface of the lower area 1062 of the lower sleeve 106, so as to provide the tightness at said lower portion.

A more sophisticated variant of the element 10 according to the invention is shown in FIG. 5. In this variant, the element 10 comprises in the lower end portion thereof an air injector 111 that extends around the central tube 107, and whereof the function is to enable the injection of air between the hollow fibers 102 during cleaning phases.

This air injector 111 has the form of a hollow cylinder that passes through, fluid-tightly, the bottom wall 1081 of the cap 108 and that fits around the lower portion of the central tube 107, so as to come out all around the latter, above the lower coating block 104, in the middle of the bundle of fibers 101, as indicated in 1110 in FIG. 5. The air injector 111 attaches in particular in the bottom wall 1081 of the cap 108 by screwing, a threaded area of the air injector being for example suitable for being screwed into a complementary tapped area formed in the bottom wall 1081 of the cap 108.

O-rings 1185, for example two in number in the figure, are inserted between the air injector 111 and the bottom wall 1081 of the cap 108, so as to provide the tightness of the attachment between said components.

The air injector 111 is pierced over the peripheral surface thereof with openings 1111 enabling the exit of the air that circulates in the injector into the bundle of fibers 102, around the central tube 107.

The air injector 111 is further pierced with an inner channel 1112, which, when the air injector is placed in the operating position thereof around the central tube 107, is in hydraulic communication with on the one hand the central tube 107 and on the other hand the lower chamber 109. This channel 1112 enables the circulation of the liquid contained in the lower chamber 109 to the inside of the central tube 107, as illustrated in 1113 in FIG. 5.

The element 10 according to the invention may be manufactured as follows.

The hollow fibers 102 are assembled in a bundle around the central tube 107, so that the latter extends at least over the entire height of the bundle 101.

The upper end portion of the fibers 102 is coated in a first coating block 103 closing neither the fibers 102, nor the central tube 107 in the upper end portion of the fibers. Preferably, the upper end 1021 of the fibers 102 and the upper end 1071 of the central tube 107 come to the level of the surface of the coating block 103.

The lower end portion of the fibers 102 is coated in a second coating block 104 closing neither the fibers 102, nor the central tube 107 in the lower end portion of the fibers. Preferably, the lower end 1022 of the fibers 102 and the lower end 1072 of the central tube 107 come to the level of the surface of the coating block 104.

The upper sleeve 105 and the lower sleeve 106 are placed at the two opposite end portions of the bundle 101, and the grid 110 is assembled on said sleeves 105, 106.

The cap 108 is fluid-tightly attached at the lower sleeve 106, so as to provide, between same and the second coating block 104, the lower chamber 109 in hydraulic communication with the hollow fibers 102 and with the central tube 107.

If applicable, the air injector 111 is screwed into the bottom wall 1081 of the cap 108, arranged around the central tube 107.

Said operations are easy and quick to produce.

### Water Filtration Module

FIG. 6 shows a filtration module 20 according to an exemplary embodiment of the invention.

Several tens of filtration elements, which may be exclusively elements 10 according to the invention, or a mixture of said elements and of conventional filtration elements 11, are incorporated into this filtration module 20.

For example, forty-nine filtration elements may be arranged there in three concentric circles, at a rate of ten, sixteen and twenty-three elements arranged on said three concentric circles, leaving free a central space for injecting water to be treated. It is clear that said filtration elements are arranged so as to leave the minimum unused space between one another, to minimize the volume of the module 20.

As can be seen in FIG. 6, the filtration module 20 described here by way of example includes a casing 13, mainly cylindrical, terminated in the lower end thereof by a base 14, and in the upper portion thereof by a cover 15. The base 14 and the cover 15 each substantially have a flattened half-ellipsoid shape.

In the present example described here by way of non-limiting example, the module 20 has a height of approximately 2 m for a diameter of 60 cm. However, it is clear that this diameter may be raised arbitrarily to substantially higher values, according to the number of filtration elements incorporated into the module 20, which is directly linked to the volume of water to be treated per hour of operation. In the case for example of a module 20 comprising approximately 200 filtration elements, the diameter may reach 1.2 m.

The base 14 is secured to the casing 13 by joint molding during the manufacture, welding, bonding or other technique suitable for the material constituting the casing 13. The latter may in particular be made of composite material in the case of seawater treatment, or stainless or coated steel, or even made of plastic material in the case of a freshwater treatment module.

This base 14 comprises a central opening 141, intended for the passage of an aeration nozzle 142, and a lateral opening 143 intended for the evacuation of washing sludges collected in a lower washing sludge collection chamber 144 formed in the base 14. A filtration sludge evacuation drain 1430 can be connected to said lower washing sludge collection chamber 144 at the lateral opening 143.

The filtration elements 10 are for example held in place within the casing 13 by:

a positioning plate 16 at the top of the module, onto which the elements 10 are suspended,

a baseplate 17, to which, if applicable, are connected the air injectors 111 of the elements 10.

The baseplate 17 may be linked to the aeration nozzle 142, and comprise a circuit 171 distributing air from said aeration nozzle 142 to the various air injectors 111 of the elements 10 incorporated into the module 20.

The baseplate 17 also comprises a set of through holes intended to enable water to pass freely between the area located above and the area located below said baseplate 17.

The materials forming the positioning plate 16 and the baseplate 17 are determined by the nature of the water to be treated: freshwater or seawater, in a way known to the person skilled in the art.

The cover 15 is removable. It is attached on the casing 13 by means of an attachment device conventional in itself, which will not be described here.

The cover 15 comprises a central opening 151 enabling the passage of a pipe 1510 supplying water to be filtered. A seal provides the tightness between the cover 15 and the pipe 1510.

An upper permeate collection chamber 154 is formed in the cover 15.

The cover 15 also comprises a lateral opening 153 intended for the recovery of the filtration permeate. A filtration permeate collection pipe 1530 may be connected to the upper permeate collection chamber 154 at the lateral opening 153.

For obvious reasons, the pipe 1530 for collecting the purified water is of diameter substantially equal to the diameter of the pipe 1510 supplying water to be filtered. In the present example, said diameter is approximately 10 cm (for a flow rate of a few tens of m³/h).

A strainer 18, coaxial with the longitudinal axis of the filtration module 20 and of length substantially equal to the length of the casing 13, is arranged between the bottom of the pipe 1510 supplying water to be filtered, and the baseplate 17, whereon it rests and to which it is attached by screwing. This strainer 18 is closed at the lower end 181 thereof and connected to the pipe 1510 supplying water to be filtered at its opposite upper end 182. The strainer 18 is of a type known per se. It is made of plastic material or stainless steel, according to the type of water to be treated (thickness a few tens to a few hundreds of μm).

It is understood that the strainer 18 is intended to distribute the water to be purified from top to bottom in the filtration module 20, towards the filtration elements 10.

In alternative embodiments of the invention, not shown in the figures, the filtration module 20 is devoid of supply strainer. The water to be filtered is for example brought therein by a pipe connected at the lower end of the filtration module. The filtration module 20 is then equipped, for example at the upper end thereof, with a pipe carrying out the purge of the air contained in the filtration module.

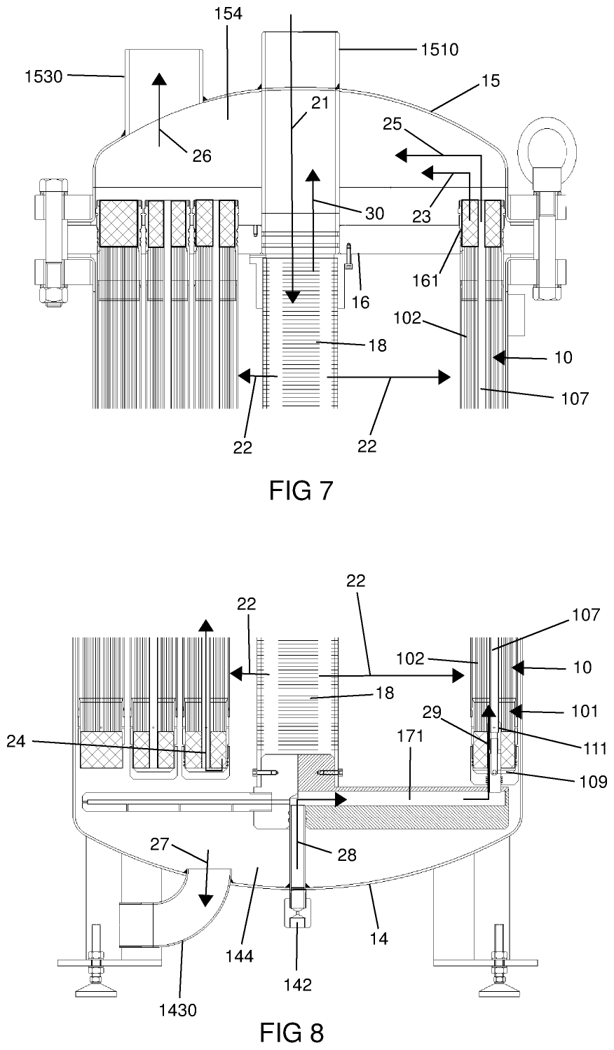

The elements 10 are attached to the positioning plate (upper plate) 16 by means of upper sleeves 105, conventionally in itself, by cooperating assemblers 161 carried respectively by the upper sleeves 105 and the positioning plate 16 (in the form of cooperating threaded areas in the embodiment of FIG. 7) and so as to be easily dismantlable, for example to realize the maintenance of the module by replacing certain worn elements.

For the mounting of the module 20, the casing 13, already with the baseplate 17, is secured to the evacuation line of the drain 1430 and to the aeration nozzle 142. Then, the central strainer 18 is installed and screwed to the baseplate 17. The positioning plate 16 is then arranged resting on a flange of the casing 13.

The elements 10 are then inserted into the module 20.

Each element 10 is attached by screwing the upper sleeve 105 to the positioning plate 16. If applicable, the air injectors 111 are connected to the air distribution circuit 171 of the baseplate 17.

Once the elements 10 have been installed, the cover 15 is installed and attached.

The pipes supplying water to be treated 1510 and recovering filtration permeate 1530 are then connected to the cover 15.

### Operating Mode

The operation of the module 20 will be described in a more detailed manner with reference to FIGS. 7 and 8, which show views of the upper and lower portions of the module 20, respectively.

In normal operation (filtration), the water to be treated is injected by the pipe supplying water 1510 into the strainer 18, as illustrated in 21 in FIG. 7. It is then distributed pressurized around elements 10, as illustrated in 22 in FIGS. 7 and 8, and passes through the membrane of the hollow fibers 102 of the elements 10.

The water thus purified, partly, rises inside the hollow fibers 102 and exits therefrom at the upper portion of same, in the upper filtration permeate collection chamber 154, as indicated in 23 in FIG. 7.

The other part of purified water goes down inside the hollow fibers 102 to the lower chambers 109, from where it reaches, because it is exposed to pressure, the associated central tubes 107 wherein it rises, as indicated in 24 in FIG. 8. Reaching the top of the central tubes 107, the filtered water gets to the upper filtration permeate collection chamber 154, as indicated in 25 in FIG. 7.

The purified water is then collected by the filtration permeate collection pipe 1530, as indicated in 26 in FIG. 7.

Said filtration operations may be carried out at low inlet water pressure, while having a significant filtration efficiency.

The module 20 is regularly subjected to a backwash, the water being injected via the interior of the hollow fibers, so as to detach the filtration sludges that naturally stick there during normal operation. The washing sludges then fall into the lower collection chamber 144 and are evacuated by the drain 1430, as indicated in 27 in FIG. 8.

Another method for washing the fibers 102 consists in injecting pressurized air by the air injectors 111, from the aeration nozzle 142, and in the middle of the bundle of hollow fibers of each element 10, as indicated respectively in 28 and 29 in FIG. 8. The very turbulent air and water flow thus created shakes and causes the expansion of the bundle of fibers 101, as well as the cleaning of the outer walls of the hollow fibers 102. This cleaning is all the more effective as the air has been injected in the actual middle of the bundle of fibers 101. The air is then evacuated at the upper portion by the strainer 18, as indicated in 30 in FIG. 7.

The method for washing the strainer 18 comprises a backwash wherein, firstly, the sludge is directed towards the bottom of the module 20. In this way, at the beginning of the backwash when the quantity of particles is significant, the flow does not pass back through the strainer 18 (which could block same).

Secondly, at the end of backwashing the fibers 102, the backwash water becomes increasingly clean and the strainer 18 is then washed in the reverse direction, therefore upwardly, optionally by adding an injection of air at the center of the bundle of fibers 101, which contributes to increasing the effectiveness of the washing.

The fibers 102 being better washed, the filtration efficiency of the module 20 is maintained better over time than when the filtration elements included in said modules are not in accordance with the present invention.

1-14. (canceled)

15. A hollow-fiber water filtration module, comprising:
a casing having a longitudinal axis;
a plurality of water filtration elements independent from one another, assembled removably in said casing to extend along said longitudinal axis, each of the plurality of water filtration elements comprising:
a plurality of longitudinal hollow fibers configured to enable a filtration of water from an outside towards an inside of the plurality of longitudinal hollow fibers, the plurality of longitudinal hollow fibers forming a bundle of fibers extending along the longitudinal axis and having an upper end portion and an opposite lower end portion; and
wherein the upper end portion of the plurality of longitudinal hollow fibers is included in a first rigid coating block, the first rigid coating block not closing the plurality of longitudinal hollow fibers in the upper end portion;
an upper permeate collection chamber in hydraulic communication with the plurality of longitudinal hollow fibers of all of the plurality of the water filtration elements;
wherein in each of the plurality of water filtration elements:
the lower end portion of the plurality of longitudinal hollow fibers is included in a second rigid coating block, the second rigid coating block not closing the plurality of longitudinal hollow fibers in the lower end portion; and
a longitudinal hollow tube, called a central tube, is arranged in a center of the bundle of fibers to extend at least over an entire height of the bundle of fibers and to open on either side of the first coating block and of the second coating block; and
wherein each water filtration element comprises a cap fluid-tightly attached around the second coating block, the cap being arranged to provide, between same and the second coating block, a chamber in hydraulic communication with the plurality of longitudinal hollow fibers and with the central tube; and
wherein the central tubes of each of the plurality of water filtration elements are in hydraulic communication with the upper permeate collection chamber at the upper portion of the plurality of longitudinal hollow fibers.

16. The water filtration module of claim 15, wherein, in at least one of the plurality of water filtration elements, the cap is irreversibly attached around the second coating block.

17. The water filtration module of claim 15, wherein, in at least one of the plurality of water filtration elements, the cap is reversibly attached around the second coating block.

18. The water filtration module of claim 15, wherein, in at least one of the plurality of water filtration elements, a shape of the bundle of fibers is maintained by a grid that surrounds same.

19. The water filtration module of claim 15, wherein at least one of the plurality of water filtration elements comprises an upper sleeve fitting tightly around the bundle of fibers at the upper end portion thereof and a lower sleeve fitting tightly around the bundle of fibers at the lower end portion thereof.

20. The water filtration module of claim 15, further comprising an upper plate arranged in the casing.

21. The water filtration module of claim 20, further comprising a cooperating assembler, supported respectively by the upper plate and by the plurality of water filtration elements, to removably assemble the plurality of water filtration elements to the upper plate.

22. The water filtration module of claim 15, further comprising a strainer in the casing, coaxial with the longitudinal axis and of a length substantially equal to a length of the casing.

23. The water filtration module of claim 22, wherein the strainer is arranged at a center of the casing, the plurality of water filtration elements being arranged around the strainer.

24. The water filtration module of claim 15, wherein at least one of the plurality of water filtration elements comprises an air injector extending around the central tube at the lower end portion of the plurality of longitudinal hollow fibers and opening into the bundle of fibers beyond the second rigid coating block, in a middle of the bundle of fibers.

25. The water filtration module of claim 24, further comprising a baseplate comprising a circuit distributing air from an aeration nozzle to the air injector.

26. A method for manufacturing a water filtration module of claim 15, comprising:
manufacturing the plurality of water filtration elements, comprising for each of the plurality of water filtration elements:
assembling hollow fibers in a bundle around a longitudinal hollow central tube, the longitudinal hollow central tube extending at least over an entire height of the bundle of fibers;
coating an upper end portion of the hollow fibers in a first coating block not closing the hollow fibers and not closing the longitudinal hollow central tube at the upper end portion, and coating a lower end portion of the hollow fibers in a second coating block not closing the hollow fibers and not closing the longitudinal hollow central tube at the lower end portion;
fluid-tightly attaching a cap around the second coating block, the cap being arranged to provide, between same and the second coating block, a chamber in hydraulic communication with the hollow fibers and with the central tube; and
assembling removably the plurality of water filtration elements in a casing, so that an upper permeate collection chamber of the water filtration module is in hydraulic communication with the hollow fibers and the central tubes of all of the plurality of water filtration elements at the upper portion of the hollow fibers.

27. A water treatment installation comprising:
a water filtration module of claim 15;
a pipe supplying water to be filtered; and
a filtration permeate collection pipe connected to the upper permeate collection chamber.

28. The water treatment installation of claim 27, further comprising a compressed air distribution system linked to an aeration nozzle of the water filtration module.

29. The method for manufacturing the water filtration module of claim 26, wherein a shape of the bundle of fibers is maintained by a grid that surrounds same.
